(19) United States
(12) Patent Application Publication
(10) Pub. No.: US 2013/0304866 A1
(43) Pub. Date: Nov. 14, 2013

(54) SYSTEM AND METHOD OF UTILIZING WIRELESS USB DEVICE AS LOCAL PROXY FOR CLOUD STORAGE

(71) Applicants: John Jun Wu, San Diego, CA (US); Sangram Tidke, San Diego, CA (US); Arup Bhattacharya, San Diego, CA (US)

(72) Inventors: John Jun Wu, San Diego, CA (US); Sangram Tidke, San Diego, CA (US); Arup Bhattacharya, San Diego, CA (US)

(73) Assignee: NOVATEL WIRELESS, INC., San Diego, CA (US)

(21) Appl. No.: 13/471,264

(22) Filed: May 14, 2012

(51) Int. Cl. G06F 15/16

(52) U.S. Cl. 709/219

(57) ABSTRACT

Systems and methods are provided for making cloud storage more easily accessible using a wireless device, such as, e.g., a wireless Universal Serial Bus (USB) dongle/modem, mobile hotspot device, etc. In particular, the wireless USB device is used to emulate a standard mass storage class device, thus allowing a user local data access to the wireless USB device. This “local” data access is then translated to remote data access with respect to the actual cloud storage allowing cloud storage to be effectuated without additional login procedures and without the opening/installation of cloud storage-specific applications.

### TECHNICAL FIELD

The present application relates generally to portable communications devices, and more particularly, to using memory aspects of such portable communications devices as a local proxy for cloud storage.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Cloud storage refers to networked online storage systems where data is stored in virtual storage pools, which are generally hosted by third parties. Hosts operate, e.g., large data centers, wherein storage capacity may be leased or bought by users. The host operators virtualize the resources according to the requirements of the customer and expose them as storage pools, which the customers can themselves use to store files or data objects. Physically, a storage resource may span across multiple servers and multiple locations.

Cloud storage services may be accessed through a Web service application programming interface (API), or through a Web-based user interface. Certain advantages are gained via the use of cloud storage. For example, users need only pay for the storage they actually use. Additionally, local physical storage devices do not need be installed at a user's location, while storage maintenance tasks, such as backing up data, data replication, and purchasing additional storage devices are offloaded to the responsibility of the host operator. Additionally still, cloud storage provides users with immediate access to a broad range of resources and applications hosted in the infrastructure of another organization via a Web service interface. Further still, advantages of utilizing a cloud storage system include the ability for an end user to retrieve his/her data from any location that has Internet access. A further example of the advantages of utilizing a cloud storage system is that users can offload backup and archiving processes.

As described above, host operators of cloud storage systems often operate large data centers, but at its most basic level, a cloud storage system needs a single data server connected to a data network, such as the Internet. A client (e.g., a user, computer, or other entity subscribing to a cloud storage service) sends copies of files over the Internet to the data server upon which the data is recorded/stored. When the client wishes to retrieve the data, he/she accesses the data server through a Web-based interface. The data server then either sends the data/files back to the client, or allows the client to access and/or manipulate the data/files on the server itself.

Examples of known cloud storage systems/services include, but are not limited to the following. Google Docs™ allows users to upload documents, spreadsheets, and other data files to Google's data servers. Users may edit files, publish documents, etc. Web e-mail providers such as Gmail™, Hotmail® and Yahoo!® Mail store e-mail messages on their own servers. Users can access their e-mail from computers and other devices connected to the Internet. Sites like Flickr® and Picasa™ host digital photographs. Users of these services may, e.g., create online photo albums by uploading pictures directly to the services' servers. YouTube™ hosts user-uploaded video files. Web site hosting companies such as, e.g., StartLogic™ Hostmonster™ and GoDaddy® store files and data for client Web sites. Even social networking sites such as Facebook® or MySpace™ allow members to post pictures and other content, all of which is stored/hosted on the respective site's servers. Other storage services such as, e.g., Xdrive® and Strongspace offer storage space for any kind of digital data.

However, drawbacks to utilizing cloud storage systems/methods exist. For example, in order to access cloud storage, as alluded to previously, an end user must log in to the website of a cloud storage operator/service provider. Alternatively, an end user may need to download a specialized application onto his/her computing device in order to be able to interface with the cloud storage server/service. For example, certain cloud storage services have developed specialized applications that run on an end user's computing device to emulate a hard drive, or alternatively provide a drop box within a Web browser where a user may “drop” files he/she wishes to store in cloud storage. Thus, utilization of a cloud storage service/system adds yet another login/password or application (or even another Web browser window/application instance) to the ever-increasing amount of access mechanisms/electronic “clutter” relied upon by computer users. Such additional steps/requirements are an added hassle for an end user.

### SUMMARY

Various aspects of examples of the invention are set out in the claims. According to a first aspect, a method comprises, upon detection of activity on a mass storage device, automatically initiating an embedded data call to a cloud storage server. The method further comprises converting between a standard mass storage request that is received at or is useable by the mass storage device and a cloud storage request that is useable by or is sent from the cloud storage server, respectively. Additionally still, the method comprises seamlessly transferring data between a host computing device operatively connected to the mass storage device and the cloud storage server based on one of the standard mass storage request or the cloud storage server request.

According to a second aspect, a computer-readable memory includes computer executable instructions, the computer executable instructions, which when executed by a processor, cause an apparatus to: upon detection of activity on the apparatus, automatically initiate an embedded data call to a cloud storage server; convert between a standard mass storage request that is received at or is useable by the apparatus and a cloud storage request that is useable by or is sent from the cloud storage server, respectively; and seamlessly transfer data between a host computing device operatively connected to the apparatus and the cloud storage server based on one of the standard mass storage request or the cloud storage server request.

According to a third aspect, an apparatus comprises at least one processor and at least one memory. The at least one memory includes computer program code, the at least one memory and the computer program code configured to, with the at least one processor, cause the apparatus to perform at least the following: upon detection of activity on the apparatus, automatically initiate an embedded data call to a cloud storage server; convert between a standard mass storage request that is received at or is useable by the apparatus and a cloud storage request that is useable by or is sent from the cloud storage server, respectively; and seamlessly transfer data between a host computing device operatively connected to the apparatus and the cloud storage server based on one of the standard mass storage request or the cloud storage server request.

According to a fourth aspect, a wireless connectivity device comprises a host computing device interface configured to permit interaction with a host computing device. The wireless connectivity device further comprises at least one processor, and at least one memory including firmware, the at least one memory and the firmware configured to, with the at least one processor, cause the wireless connectivity device to perform at least the following: upon detection of storage-related activity on the wireless connectivity device, automatically initiate an embedded data call to a cloud storage server; and seamlessly transfer data between the host computing device operatively connected to the wireless connectivity device and the cloud storage server, wherein the wireless connectivity device is configured to emulate a mass storage device, and is further configured to convert a standard mass storage request received at the wireless connectivity device to a cloud storage request useable by the cloud storage server based upon receipt of a first storage-related request and convert the cloud storage request to the standard mass storage request based upon a second storage-related request.

According to a fifth aspect, a system comprises: a host computing device; a remote cloud storage server; and a wireless universal serial bus (USB) modem configured to be locally connected to the host computing device as an emulated mass storage device, wherein the wireless USB modem, upon detection of storage-related activity on the wireless connectivity device, automatically initiates an embedded data call to the remote cloud storage server, and seamlessly transfers data between the host computing device and the remote cloud storage server by converting between standard mass storage requests and cloud storage requests and bypassing physical write/read actions to/from the emulated mass storage device, instead executing write/read actions on the remote cloud storage server.

### BRIEF DESCRIPTION OF THE DRAWINGS

For a more complete understanding of example embodiments, reference is now made to the following descriptions taken in connection with the accompanying drawings in which:

FIG. 1 illustrates an exemplary wireless connectivity device in accordance with various embodiments of the present invention;

FIG. 2 is a schematic representation of exemplary components of the exemplary wireless connectivity device of FIG. 1;

FIG. 3 illustrates a exemplary scenario from an end user perspective wherein a wireless connectivity device may be used to more efficiently and easily effectuate cloud storage in accordance with various embodiments of the present invention;

FIG. 4 illustrates system architecture elements involved in a wireless connectivity device being used to more efficiently and easily effectuate cloud storage in accordance with various embodiments of the present invention; and

FIG. 5 is a flow chart illustrating exemplary processes performed in accordance with various embodiments of the present invention to effectuate cloud storage via a wireless connectivity device.

### DETAILED DESCRIPTION OF THE DRAWINGS

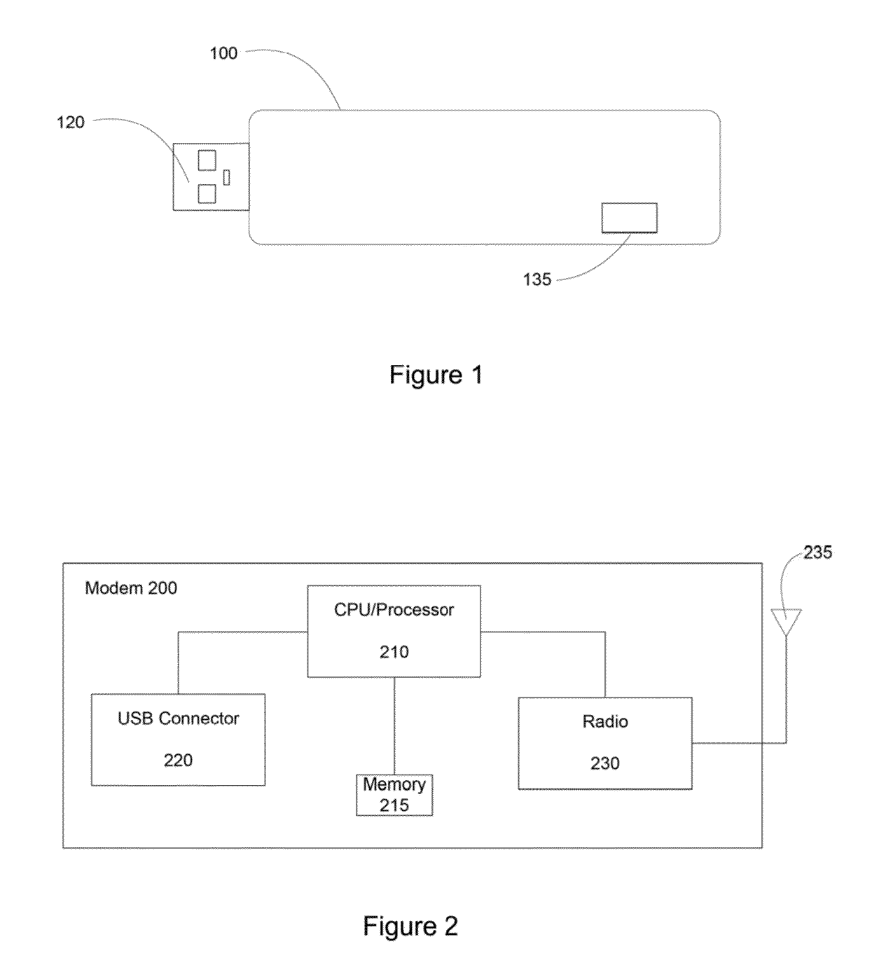

Example embodiments and their potential advantages are understood by referring to FIGS. 1-5 of the drawings.

Various embodiments of the present invention are directed to making cloud storage more easily accessible using a wireless device, such as, e.g., a wireless Universal Serial Bus (USB) dongle/modem. In particular, the wireless USB device is used to emulate a standard mass storage class device, thus allowing a user local data access to the wireless USB device. This “local” data access may then be translated to remote data access with respect to the actual cloud storage (and vice versa). Thus, a single step solution for access cloud storage is provided, as opposed to the aforementioned multi-step approach conventionally utilized by users. That is, a user need only plug a wireless USB device into, e.g., a computing device, such as a laptop computer, and the user will be presented with a mass storage device/interface that (in the background) will translate to cloud storage access without any driver/application installation and/or extra login procedure(s).

Radio/Radio frequency (RF) modems are RF transceivers for data, and receive and transmit signals from other radio modems. RF modems may be internally or externally mounted. As described above, USB modems are one example of externally mounted radio modems. Current wireless RF modems that cooperatively operate with a host computing device typically include: (1) a radio portion, also called an RF front end or an RF head; (2) a modulator/demodulator portion, also called a baseband processing unit or baseband chip; (3) a central processing unit (CPU) or processor; (4) a memory; and (5) an interface. These modems generally operate using software code to communicate between a user and a base station. The above modem components collectively operate during a wireless communications process to receive an electromagnetic RF signal in a receive mode. The RF signal contains information to be extracted from the received RF signal, and in a transmit mode, wherein the components work collectively to transmit an electromagnetic RF signal, the RF signal contains the information to be transmitted. Moreover, during receive and transmit modes, the modem components collectively operate to perform three principal modem functions: RF conversion, baseband processing and protocol stack control.

Typically, during RF conversion, the radio receives the RF signal during the receive mode and converts that RF signal into a modulated baseband analog signal and, during the transmit mode, the RF head converts a modulated baseband analog signal into an RF signal for transmission. During baseband processing, the baseband processing unit in the receive mode demodulates the modulated baseband analog signal by extracting a plurality of data bits that correspond to the information being received. In the transmit mode, the baseband processing unit generates the modulated baseband analog signal for processing by the radio.

As part of the above wireless communications process, data bits being transmitted are wrapped with protocol bits of data to facilitate transmission, routing, and receiving of the data bits. Likewise, this protocol data is removed to accurately reproduce, in the receiving RF modem, the data that was sent. The adding or stripping of the protocol bits, also called protocol stack control, is generally performed by the processor in the RF modem under the control of a protocol stack software program stored in the RF modem's memory. Finally, the interface feeds the data bits from the host computer to the RF modem for processing and transmission, and feeds to the host computer the reproduced data bits that were extracted from the received RF signal.

The host computing device may typically be a laptop or palmtop computer, or a Personnel Digital Assistant (PDA). The host computing device may also be other types of battery powered devices such as a point of sale terminal, a wireless meter reader, a wireless sensor transmitter, or some other computing system. Typical interfaces between the wireless RF modem and the host computer are RS-232, USB as mentioned above, Parallel Port, IrDa, PCMCIA, Flash, Compact Flash, a low voltage serial interface, or local wireless protocols such as WiFi™, Bluetooth®, or Zigbee®. However, other interfaces are also used, including a variety of other standard or proprietary interfaces. It should be noted that USB stick/dongle communications devices, such as USB modems may be embodied in configurations that include, but are not limited to, straight USB sticks, swivel USB sticks, fixed angular USB sticks, etc.

Further regarding the radio aspects of RF modems, modems may be configured to operate within certain frequency bands that include, e.g., the 900 MHz, 2.4 GHz, 5 GHz, 23 GHz, Very High Frequency (VHF), and Ultra High Frequency (UHF) ranges. Operating modes for radio modems may include point-to-point, point-to-multipoint, and repeater modes. Point-to-point radio modems can transmit to only one modem/radio modem at a time. Point-to-multipoint modems can transmit to several modems/radio modems at a time.

Radio techniques include direct sequence spread spectrum and frequency hopping spread spectrum, where spread spectrum is used to reduce the impact of localized frequency interferences. To achieve this, it uses more bandwidth than the system needs. There are two main spread spectrum modalities: direct sequence and frequency hopping. The principle of direct sequence spreads the signal on a larger band by multiplexing it with a code (signature) to minimize localized interference and noise. The modem works over a large band. To spread the signal, each bit is modulated by a code. Frequency hopping uses a technique where the signal walks through a set of narrow channels in sequence. The transmission frequency band is divided in certain number of channels, and periodically the modem hops to a new channel, following a predetermined cyclic hopping pattern. The modem avoids interference by never staying in the same channel a long period of time.

Radio techniques may also include orthogonal frequency division multiplexing (OFDM), which is a technique where a data message is split into fragments, and using a single transmitting source. The fragments are then simultaneously transmitted over a cluster of, e.g., adjacent, RF channels, where all the RF channels operate using the same modulation and coding type and are controlled by the same protocol rules.

Further still, common performance aspects of radio modems include full duplex transmission, maximum output power, number of channels, and sensitivity. Full duplex radio modems can transmit and receive at the same time. Maximum output power is the transmission power of the device, and is defined as the strength of the signals emitted, often measured in mW. The number of channels defines the number of transmitting and receiving channels of the device, while a modem's sensitivity may be measured by the weakest signal that may be reliably sensed by the receiver.

FIG. 1 illustrates an exemplary wireless communications device 100. The device 100 may be a wireless USB modem configured for connection to a host device, such as a laptop computer. The connection to the host device may be effectuated via a connection interface, in this case, a USB connector 120 that may be inserted into the USB port of the host device. Additionally, the device 100 may have at least one antenna 135 for the transmission/receipt of data/signals.

FIG. 2 illustrates a modem 200, which provides a schematic representation of the device 100 illustrated in FIG. 1. Modem 200 may include at least one central processing unit (CPU)/processor 210 and at least one memory unit 215. Modem 200 may further include a USB connector 220 allowing the modem 200 to be connected to a host device. Moreover, the modem 200 includes at least one radio 230, the radio 230 comprising a transmitter and receiver, and a baseband unit (not shown). Connected to the radio 230 is an antenna 235.

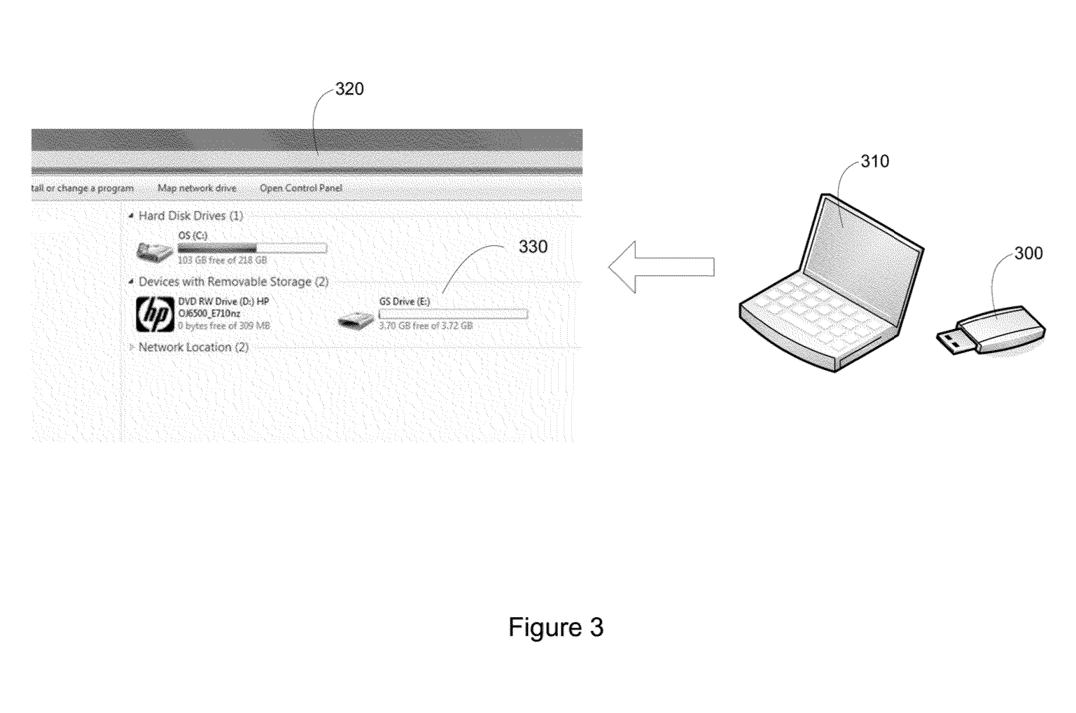

As previously described, and in accordance with various embodiments of the present invention, a user may insert a USB device, such as, e.g., a wireless broadband USB modem into a host computing device to effectuate access to cloud storage services. As illustrated in FIG. 3, a USB device 300 may be inserted or otherwise operatively connected to a host computing device 310. Upon insertion of the USB device 300 into the host computing device 310, and commensurate with known operating system behavior (e.g., Microsoft® Windows® 7), a window 320 may be displayed to a user. Because the USB device 300 is configured to emulate an actual mass storage class device, in the window 320, the USB device 300 appears as a local and actual mass storage class device.

To emulate an actual mass storage class device, but operate as a cloud storage interface, mass storage actions/commands received from a user at the host computing device 310/USB device 300 are converted to requests used/usable by a cloud storage server. Conversely, actions/commands from the cloud side are converted to mass storage class device actions/commands. It should be noted that the standard protocol used for USB mass storage devices is the Small Computer System Interface (SCSI) for physically connecting and transferring data between computers and peripheral devices. The protocol typically used in cloud storage systems is Hypertext Transfer Protocol Secure (HTTPS) to provide encrypted communications and secure identification of network Web servers. However, various embodiments of the present invention contemplate converting between any appropriate protocols used on the mass storage side and the cloud storage side.

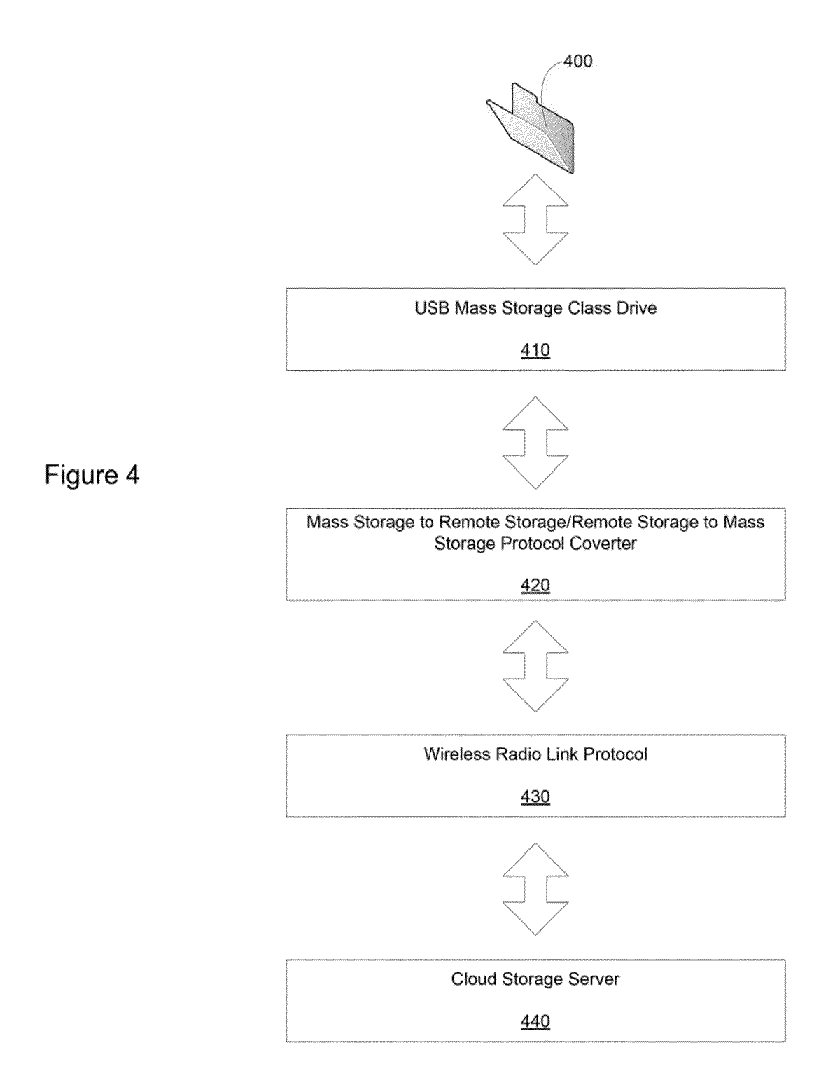

FIG. 4 illustrates in greater detail, the aforementioned capability of various embodiments to emulate a mass storage class device while providing cloud storage. A file/folder 400 representative of data may be stored on an emulated USB mass storage class drive 410. A mass storage to remote storage/remote storage to mass storage protocol converter 420 converts mass storage actions/commands to those recognizable/useable by a cloud storage server. A wireless radio link protocol 430 is utilized to transmit the data 400 to one or more cloud storage servers 440. As discussed above, these operations may be performed in reverse as well. That is, actions, requests, etc. from the cloud storage server 440 side may be transmitted via the wireless radio link protocol 430, and the converter 420 converts the cloud storage side actions, requests, etc. into mass storage actions, requests, etc. to effectuate interaction with the USB mass storage class drive 410.

To provide the functionality disclosed herein in accordance with various embodiments, a wireless connectivity device, such as a wireless USB modem, includes one or more flash memory units with at least one of its flash memory units partitioned and configured to operate as a standard mass storage class device. It should be noted that wireless connectivity devices, such as wireless USB modems, can have integrated therein, removable flash memory devices, such as, e.g., Secure Digital (SD) cards, which already operate as a standard mass storage class device, and may be configured to provide cloud storage connectivity as will be described in greater detail. It should be further noted that as only a “portion” of flash memory is needed to effectuate cloud storage in accordance with various embodiments, other partitions of the one or more flash memory units may still be utilized as conventional memory storage. Thus, a user may “see” and utilize more than one mass storage class device upon insertion of a wireless USB modem into a host computing device, where one mass storage class device commensurate with one partition may operate as conventional storage, while another partition may provide cloud storage.

A local partition on a mass storage class device can also be used to cache data being sent to cloud storage or to pre-fetch data from cloud storage that may be needed in the future. Such caching/pre-fetching capabilities allow for automatic recovery in the event intermittent RF connectivity issues arise, for optimization of automatic backup of information, and for improved observed performance.

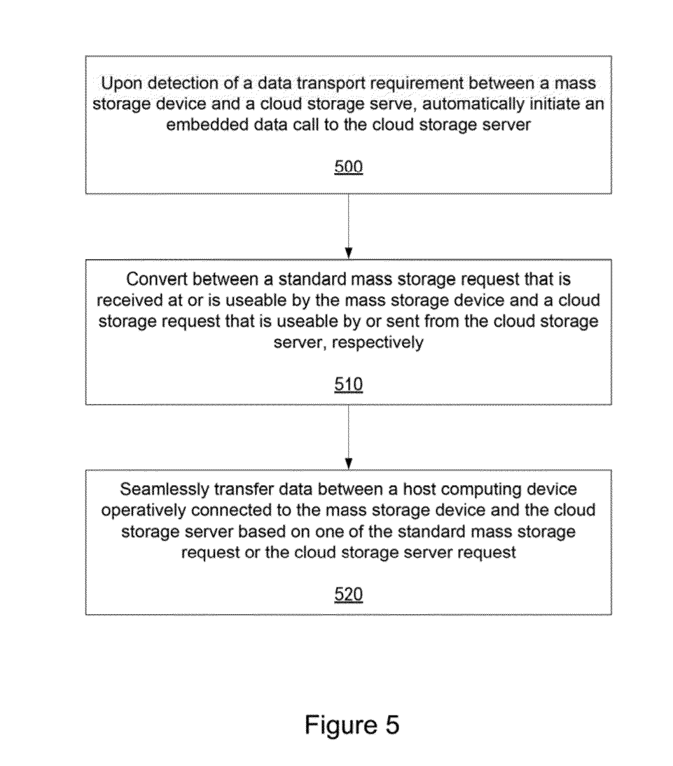

FIG. 5 illustrates exemplary processes performed in accordance with various embodiments of the present invention to provide cloud more easily accessible/useable cloud storage via a wireless USB connectivity device. At 500, and upon detection of activity on a mass storage device, an embedded data call to a cloud storage server is automatically initiated. Such a connection may be established using, e.g., a Secure Sockets Layer (SSL) connection. At 510, a standard mass storage request received at the mass storage device is converted to a cloud storage request useable by the cloud storage server. At 520, data is seamlessly transferred at least one of to and from a host computing device operatively connected to the mass storage device and the cloud storage server based on the standard mass storage request.

The exemplary processes described with respect to FIG. 5 may be performed by a task in firmware running on a wireless USB device. Moreover, and additionally, physical read/writes from/to the emulated mass storage device are avoided by utilizing, e.g., a Zero-Copy streaming file transfer protocol (FTP), although any appropriate protocol/mechanism may be utilized to bypass actual local mass storage activity. Rather read/writes from/to the emulated mass storage device are seamlessly transferred to/from the cloud storage server without the need to temporarily store any data on the mass storage device.

Furthermore, a wireless USB connectivity device to be utilized to effectuate cloud storage as disclosed herein may be configured to use a particular cloud storage user account including, but not limited to, e.g., Cloud Storage Server uniform resource identifier (URI), Server Authentication credentials, and/or Server Encryption keys. To uniquely identify a particular wireless USB connectivity device to properly link a cloud storage user account therewith may be accomplished by utilizing, e.g., an International Mobile Equipment Identity (IMEI) or an Electronic Serial Number (ESN)/Mobile Equipment Identifier (MEID) associated with the wireless USB connectivity device.

It should be noted that although various embodiments herein have been disclosed in the context of a wireless USB modem, the functionality, methods, and systems described may be implemented in other types of devices, whether peripheral, external, or internal/embedded. For example, instead of a USB connectivity device in the form of a USB stick/dongle modem, the device may be an Express Card modem, or an embedded modem of a computing device as long as remote connectivity to a cloud storage server is enabled via some manner of local storage emulation. Moreover, certain checks may be employed to ensure proper access is provided, where, e.g., during the automatic authentication of the wireless USB connectivity device with a cloud storage server(s), a check may be performed to ensure that the particular wireless USB connectivity device requesting access is still allowed to access the particular cloud storage user account. Furthermore, various embodiments may be implemented in various types of network devices, including but not limited to, devices such as wireless routers that can act as mobile WiFi™ hotspots providing Internet or other network access for one or more peripheral computing devices. It should be noted that using Universal Plug and Play (UPnP) connectivity/protocols, such network devices can be used to automatically act as a network storage device.

Various embodiments of the present invention may be implemented in a system having multiple communication devices that can communicate through one or more networks. The system may comprise any combination of wired or wireless networks such as a mobile telephone network, a wireless Local Area Network (LAN), a Bluetooth personal area network, an Ethernet LAN, a wide area network, the Internet, etc.

The communication devices may communicate using various transmission technologies such as OFDM, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

An electronic device in accordance with embodiments of the present invention may include a display, a keypad for input, a microphone, an ear-piece, a battery, and an antenna. The device may further include radio interface circuitry, codec circuitry, a controller/CPU/processor and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
upon detection of a data transport requirement between a mass storage device and a cloud storage server, automatically initiating an embedded data call to the cloud storage server;
converting between a standard mass storage request that is received at or useable by the mass storage device and a cloud storage request that is sent from or useable by the cloud storage server, respectively; and
seamlessly transferring data between a host computing device operatively connected to the mass storage device and the cloud storage server based on one of the standard mass storage request or the cloud storage server request.

2. The method of claim 1, wherein the data transport requirement is associated with one of a data backup operation, a data pre-fetching operation, an already-transferred data update operation, or a user input action.

3. The method of claim 1, wherein the mass storage device comprises an emulated mass storage device operatively connectable to the host computing device as a wireless universal serial bus (USB) connectivity device.

4. The method of claim 1, wherein the mass storage device comprises an emulated network storage device operatively connectable to the host computing device utilizing Universal Plug and Play connectivity.

5. The method of claim 3, wherein the automatic initiating of the embedded data call, the converting, and the seamless transferring of the data is performed via a firmware task incorporated into the wireless USB connectivity device.

6. The method of claim 3, wherein a flash memory unit of the wireless USB connectivity device is partitioned, and wherein at least a portion of the partitioned section of the flash memory unit acts as the emulated mass storage device.

7. The method of claim 6, wherein a second portion of the partitioned section of the flash memory unit acts as one of a conventional mass storage device, a cache configured to store the data prior to being transferred to the cloud storage server, or a pre-fetch storage configured to store pre-fetched cloud storage data.

8. The method of claim 3 further comprising, configuring the wireless USB connectivity device to associate with a specific cloud storage account.

9. The method of claim 8, wherein the configuring of the wireless USB connectivity device comprises relying on at least one of a cloud storage server uniform resource identifier associated with the cloud storage server, server authentication credentials associated with the cloud storage server, and server encryption keys associated with the cloud storage server.

10. The method of claim 8, wherein the wireless USB connectivity device is uniquely identifiable to the specific cloud storage account based on one of an International Mobile Equipment Identity (IMEI) associated with the wireless USB connectivity device, an Electronic Serial Number (ESN) associated with the wireless USB connectivity device, or a Mobile Equipment Identifier (MEID) associated with the wireless USB connectivity device.

11. The method of claim 1 further comprising, converting another cloud storage request to another standard mass storage request useable by the mass storage device, the standard mass storage request and the another standard mass storage request conforming to a Small Computer System Interface (SCSI) protocol and the cloud storage request and the another cloud storage request conforming to a Hypertext Transfer Protocol Secure (HTTPS) protocol.

12. The method of claim 1, wherein the seamless transferring of the data comprises avoiding physical read/write actions from/to the mass storage device, and wherein the avoidance of the physical read/write actions is performed via a zero-copy file transfer protocol configured to bypass the mass storage device for the cloud storage server.

13. A computer-readable memory including computer executable instructions, the computer executable instructions, which, when executed by a processor, cause an apparatus to perform a method as claimed in claim 1.

14. An apparatus, comprising:
at least one processor; and
at least one memory including computer program code, the at least one memory and the computer program code configured to, with the at least one processor, cause the apparatus to perform at least the following:
upon detection of a data transport requirement between the apparatus and a cloud storage server, automatically initiate an embedded data call to the cloud storage server;
convert between a standard mass storage request received at or useable by the apparatus and a cloud storage request that is sent from or useable by the cloud storage server, respectively; and
seamlessly transfer data between a host computing device operatively connected to the apparatus and the cloud storage server based on one of the standard mass storage request or the cloud storage server request.

15. The apparatus of claim 14, wherein the data transport requirement is associated with one of a data backup operation, a data pre-fetching operation, an already-transferred data update operation, or a user input action.

16. The apparatus of claim 14, wherein the apparatus comprises an emulated mass storage device operatively connectable to the host computing device as a wireless universal serial bus (USB) connectivity device.

17. The apparatus of claim 14, wherein the apparatus comprises an emulated network storage device operatively connectable to the host computing device utilizing Universal Plug and Play connectivity.

18. The apparatus of claim 16, wherein the automatic initiating of the embedded data call, the converting, and the seamless transferring of the data is performed via a firmware task incorporated into the wireless USB connectivity device.

19. The apparatus of claim 16, wherein a flash memory unit of the apparatus is partitioned, and wherein at least a portion of the partitioned section of the flash memory unit acts as the emulated mass storage device.

20. The apparatus of claim 19, wherein a second portion of the partitioned section of the flash memory unit acts as one of a conventional mass storage device, a cache configured to store the data prior to being transferred to the cloud storage server, and a pre-fetch storage configured to store pre-fetched cloud storage data,

21. The apparatus of claim 14, wherein the apparatus is configured to associate with a specific cloud storage account.

22. The apparatus of claim 21, wherein the configuring of the apparatus comprises relying on at least one of a cloud storage server uniform resource identifier associated with the cloud storage server, server authentication credentials associated with the cloud storage server, and server encryption keys associated with the cloud storage server.

23. The apparatus of claim 21, wherein the apparatus is uniquely identifiable to the specific cloud storage account based on one of an International Mobile Equipment Identity (IMEI) associated with the apparatus, an Electronic Serial Number (ESN) associated with the apparatus, or a Mobile Equipment Identifier (MEID) associated with the apparatus.

24. The apparatus of claim 14, wherein the at least one memory and the computer program code configured to, with the at least one processor, further cause the apparatus to convert another cloud storage request to another standard mass storage request useable by the mass storage device, the standard mass storage request and the another standard mass storage request conforming to a Small Computer System Interface (SCSI) protocol and the cloud storage request and the another cloud storage request conforming to a Hypertext Transfer Protocol Secure (HTTPS) protocol.

25. The apparatus of claim 14, wherein the performance of the seamless transferring of the data comprises the at least one memory and the computer program code configured to, with the at least one processor, further causing the apparatus to avoid physical read/write actions from/to the apparatus, and wherein to perform the avoidance of the physical read/write actions, the at least one memory and the computer program code configured to, with the at least one processor, further cause the apparatus to utilize a zero-copy file transfer protocol configured to bypass the apparatus for the cloud storage server.

26. A wireless connectivity device, comprising:
a host computing device interface configured to permit interaction with a host computing device;
at least one processor; and
at least one memory including firmware, the at least one memory and the firmware configured to, with the at least one processor, cause the wireless connectivity device to perform at least the following:
upon detection of storage-related activity on the wireless connectivity device, automatically initiate an embedded data call to the cloud storage server; and
seamlessly transfer data between the host computing device operatively connected to the wireless connectivity device and the cloud storage server, wherein
the wireless connectivity device is configured to emulate a mass storage device, and is further configured to convert a standard mass storage request received at the wireless connectivity device to a cloud storage request useable by the cloud storage server based upon receipt of a first storage-related request and convert the cloud storage request to the standard mass storage request based upon a second storage-related request.

27. The wireless connectivity device of claim 26, wherein the data transport requirement is associated with one of a data backup operation, a data pre-fetching operation, an already-transferred data update operation, and a user input action.

28. The wireless connectivity device of claim 26, wherein the first storage-related request comprises a request to write the data to the cloud storage server from the host computing device.

29. The wireless connectivity device of claim 26, wherein the second storage-related request comprises a request to read the data from the cloud storage server at the host computing device.

30. The wireless connectivity device of claim 26, wherein the wireless connectivity device is configured to associate with a particular cloud storage account.

31. The wireless connectivity device of claim 30, wherein prior to the seamless transfer of the data, a check is performed to confirm the wireless connectivity device is allowed to access the particular cloud storage account.

32. The wireless connectivity device of claim 26, wherein the at least one memory and the firmware configured to, with the at least one processor, further cause the wireless connectivity device to utilize a zero-copy file transfer protocol configured to bypass the apparatus for the cloud storage server in executing the first storage-related request or the second storage-related request.

33. The wireless connectivity device of claim 26, wherein the host computing device interface comprises a universal serial bus (USB) interface.

34. A system, comprising:
a host computing device;
a remote cloud storage server; and
a wireless universal serial bus (USB) modem configured to be locally connected to the host computing device as an emulated mass storage device, wherein the wireless USB modem, upon detection of storage-related activity on the wireless connectivity device, automatically initiates an embedded data call to the remote cloud storage server, and seamlessly transfers data between the host computing device and the remote cloud storage server by converting between standard mass storage requests and cloud storage requests and bypassing physical write/read actions to/from the emulated mass storage device, instead executing write/read actions on the remote cloud storage server.

35. The system of claim 34, wherein the standard mass storage requests conform to a Small Computer System Interface (SCSI) protocol and the cloud storage requests conform to a Hypertext Transfer Protocol Secure (HTTPS) protocol.
